(19) United States
(12) Patent Application Publication
(10) Pub. No.: US 2024/0230508 A1
(43) Pub. Date: Jul. 11, 2024

(54) Device and method for detecting and identifying molecularly imprinted polymers in a liquid dispersion sample

(71) Applicants: INESC TEC - Instituto de Engenharia de Sistemas e Computadores, Tecnologia e Ciência, Porto (PT); Universidade do Porto, Porto (PT); ILOF - Intelligent Lab On Fiber, Unipessoal LDA, Matosinhos (PT)

(72) Inventors: Pedro Alberto DA SILVA JORGE, Porto (PT); Alessandra Maria Bossi, Verona (IT); Nunzio CENNAMO, Aversa (IT); Joana Isabel SANTOS PAIVA, Matosinhos (PT); Paulo Henrique DA COSTA SANTOS, Matosinhos (PT); Sandra Cristina MARTINS RODRIGUES, Matosinhos (PT); Cristiana Raquel DA SILVA CARPINTEIRO, Matosinhos (PT)

(21) Appl. No.: 18/559,684

(22) PCT Filed: May 9, 2022
(86) PCT No.: PCT/IB2022/054297

§ 371 Date: Nov. 8, 2023

(30) Foreign Application Priority Data
May 8, 2021 (PT) 117215

(51) Int. Cl. G01N 15/1434

(52) U.S. Cl. CPC G01N 15/1434

(57) ABSTRACT

Device and method for detecting a MIP in a liquid dispersion sample from a backscattered or scattered forward light fingerprint, including detecting binding to a target analyte, the method comprising: emitting a laser modulated by a frequency onto each specimen; capturing a temporal signal from laser light backscattered or scattered forward by each specimen for a plurality of temporal periods for each specimen; calculating specimen coefficients from the captured signal for each temporal period; using the calculated coefficients to pre-train a machine learning classifier; using a laser emitter to emit a laser modulated by a frequency onto the sample; using a light receiver to capture a signal from laser light backscattered or scattered forward by the sample for a plurality of temporal periods; calculating sample coefficients from the captured signal for each temporal period; using the classifier to classify the sample coefficients as having MIP present or not.

### TECHNICAL FIELD

The present disclosure relates to a method and device for detecting a molecularly imprinted polymer (MIP) in a liquid dispersion sample from a backscattered or scattered forward light fingerprint, in particular a method and device for detecting and identifying a molecularly imprinted polymer (MIP) trapped or dispersed in a liquid dispersion sample, further in particular a method and device for detecting and identifying a molecularly imprinted polymer (MIP) when bound to a target analyte.

### BACKGROUND

Molecular imprinting is a process of generating an impression within a solid or a gel, the size, shape and charge distribution of which corresponds to a template molecule (typically present during polymerisation). The result is a synthetic receptor capable of binding to a target analyte, for example a target analyte, which fits into the binding site with high affinity and specificity.

A molecularly imprinted polymer (MIP) is a polymer that has been processed using a molecular imprinting process which leaves cavities in the polymer matrix with an affinity for a chosen template analyte or molecule [1-2]. The process usually involves initiating the polymerization of monomers in the presence of a template analyte that is extracted afterwards, leaving behind complementary cavities. These polymers have affinity for the original analyte and can even be used to provide molecular sensors.

MIPs are small, stable micro/nanoparticles with well-defined characteristics such as size, specificity and fluorescence, and thus they are well considered for analytical or diagnosis applications. MIPs can also be used as part of thin films bound to surfaces. Due to the imprinting procedure, the MIPs are versatile and can be imprinted against various targets in vivo such as proteins, glycans or any other moieties present in living organisms. Some types of MIPs can also be referred as synthetic antibodies given the affinity and specificity to precisely defined proteins.

MIPs provide a practical and versatile means for detecting and identifying suspended target analytes, for example molecules, suspended in liquid dispersion.

However, detecting and identifying MIPs, especially when suspended in a liquid dispersion, can be very challenging. In fact, detecting and identifying MIPs in order to differentiate whether a target analyte is bound, can be even more difficult.

A prior art approach for identifying particles suspended in a liquid involves the use of optical means. In particular, the amount of light scattered by a particle has been considered a gold-standard technique for simple particle characterization, given its dependence with crucial scattered characteristics such as particle diameter, refractive index, shape/geometry, composition, content type (synthetic, biologic) and type of interactions with the surrounding media [3-4].

Applications have been reported with MIPs successfully combined with fluorescence or Raman detection to distinguish different types of analytes (proteins, enzymes, hormones, bacteria, drugs, antibiotics and pesticides) [5-7].

However, neither of these documents teaches a practical straightforward method or device that is suitable for detecting molecularly imprinted polymers (MIP) in a liquid dispersion sample. These facts are disclosed in order to illustrate the technical problem addressed by the present disclosure. Fluorescence can be used but requires additional chemistry and more complex optical detection setups, especially if very low quantities (such as single particles) are to be addressed. The following references are hereby incorporated in their entirety, in particular the disclosed MIP preparation methods and materials described in the following references.

### REFERENCES

[1] Canfarrota, F., Poma, A., Guerreiro, A., Piletski, S., “Solid-phase synthesis of molecularly imprinted nanoparticles”, Nat Protoc 11, 443-455 (2016)
[2] Xing, R., Wang, S., Bie, Z., He, H., Liu, Z., “Preparation of Preparation of molecularly imprinted polymers specific to glycoproteins, glycans and monosaccharides via boronate affinity controllable-oriented surface imprinting”, Nat Protoc 12, 964-987 (2017)
[3] Mei, Z., Wu, T., Pion-Tonachini, L., Qiao, W., Zhao, C., Liu, Z., and Lo, Y., “Applying an optical space-time coding method to enhance light scattering signals in microfluidic devices,” Biomicrofluidics 5(3), 034116 (2011).
[4] Wu, T., Cho, S., Chiu, Y., and Lo, Y., “Lab-on-a-Chip Device and System for Point-of-Care Applications,” Handbook of Photonics for Biomedical Engineering, 87-121 (2017).
[5] A. Rico-Yuste, S. Carrasco, Molecularly Imprinted Polymer-Based Hybrid Materials for the Development of Optical Sensors, Polymers (Basel) 11 (2019).
[6] Y. Saylan, S. Akgonullu, H. Yavuz, S. Unal, A. Denizli, Molecularly Imprinted Polymer Based Sensors for Medical Applications, Sensors (Basel) 19 (2019).
[7] Z. Zhang, X. Zhang, B. Liu, J. Liu, Molecular Imprinting on Inorganic Nanozymes for Hundred-fold Enzyme Specificity, J Am Chem Soc 139 (2017) 5412-5419.

### GENERAL DESCRIPTION

The present disclosure relates to a method and device for detecting a molecularly imprinted polymer (MIP) in a liquid dispersion sample, in particular a method and device for detecting and identifying a molecularly imprinted polymer (MIP) in a liquid dispersion sample, further in particular a method and device for detecting and identifying a molecularly imprinted polymer (MIP) when bound to a target analyte, i.e. a method and device for detecting and identifying a target analyte when bound to a molecularly imprinted polymer (MIP).

The present disclosure relates to method and device for detecting the modification of a MIP when bound to a target, wherein the ensemble of MIP and target can be uniquely identified by the scattering signature of the modified MIP. The disclosure can thus be said to relate to the detecting of targets using MIPs as modifiable scattering tags.

The disclosed methods and devices can provide very robust and compact configurations that allow for their integration in fixed and mobile (automated) analytical stations in a diversity of scenarios.

Bound or unbound MIPs will have differentiated shape and refractive index structures, and therefore differentiated scattering signatures. MIP synthesis strategy can be used to tailor these changes and enhance detection. MIPs, when bound to a target, seem to show modifications in conformance and weight that cause differentiated scattering signatures.

The proposed method and device can detect the presence of MIPs in complex liquid solutions. Typically, MIPs may have targets approximately ranging between 0.1 and 10 nm. MIPs can also be prepared with sizes close to the size of proteins or the size of antibodies, for example around 17 nm.

MIPs vary between nano and microscale. According to the present disclosure, MIPs may be detected and identified when dispersed (i.e. not trapped) or trapped, with MIPs at micro or nano scale.

The present disclosure is extremely useful for differentiating MIPs, in particular its binding state, in swift and simple implementations, and for detecting dispersed target molecules of very small size which would otherwise not be detectable.

The disclosure preferably includes an optoelectronic instrument which enables highly sensitive detection of selected analytes. An embodiment comprises a pigtailed fibre laser, coupled to micro-focusing elements which are coupled back to a photodetector, for scattering analysis by a computational core. In an embodiment, the focusing elements (for example, a polymeric lens in fibre/planar surface) interact with the sample in small volume flow chamber.

MIPS may be immobilized or suspended in a sample. Scattering analysis then indicates the presence or absence of bonded MIP particle or particles, and therefore the presence or absence of the target analyte.

For example, a standard optical tweezer system (inverted microscope configuration) with a quadrant photodetector (position sensitive) can also be used. Generally, any configuration capable of optical trapping at micro (tweezer setup configuration), or nano (plasmonic traps such as nanoholes, nano tapers).

The analysed samples can be filtered and dehydrated, capturing the toxic analytes and allowing for the recycling of the nano plastic materials (which can be re-used or recycled to synthetize new MIPs, depending on the strength of chemical interactions).

By developing MIPs with strong scattering response that can specifically bind to the individual target analytes, it is possible to create stronger signal signatures, that facilitate the identification of small molecules or analytes. While MIPs have been successfully used in prior art optical and electrochemical detection schemes, the present combination with AI-powered scattering analysis has not been implemented.

Specific MIPs may be designed for providing easily recognizable scattering signatures of individual analytes. In this way, strong recognizable scattering signatures allow the disclosed scattering analysis methods to robustly address the identification of selected analytes in complex matrixes.

In a particular embodiment, the disclosed device may be embedded in microfluidic microchips for rapid clinical diagnosis or, for example, to be integrated in a drug delivery system or an automated food production system for sorting and selection according with specific product criteria. For example, the aforementioned plasmonic or resonant configurations are amenable to such integration.

It is disclosed a device for detecting a molecularly imprinted polymer (MIP), including detecting whether it is bound or not bound to a target analyte, in a liquid dispersion sample, said device comprising a laser emitter; a focusing optical system coupled to the emitter; an infrared light receiver; and an electronic data processor arranged to classify the sample as having, or not having, the MIP present and whether it is bound or not bound to a target analyte using a machine learning classifier which has been pre-trained using a plurality of MIP specimens comprising specimens bound and specimens not bound to the target analyte, by a method comprising:
emitting a laser modulated by a modulation frequency onto each specimen;
capturing a temporal signal from laser light backscattered or scattered forward by each specimen for a plurality of temporal periods of a predetermined duration for each specimen; calculating specimen coefficients from the captured signal for each of the temporal periods; using the calculated coefficients to pre-train the machine learning classifier;
wherein the electronic data processor is further arranged to:
use the laser emitter to emit a laser modulated by a modulation frequency onto the sample; use the light receiver to capture a signal from laser light backscattered or scattered forward by the sample for a plurality of temporal periods of a predetermined duration;
calculating sample coefficients from the captured signal for each of the temporal periods; using the pre-trained machine learning classifier to classify the calculated sample coefficients as having, or not having, the MIP present and whether it is bound or not bound to a target analyte.

An example of a suitable optical system includes that of an optical trapping system and cooperating position sensitive sensor.

A machine learning classifier may comprise temporal and frequency-derived features extracted from a processed back-scattered signal and then projected into a single feature using the Linear Discriminant Analysis (which can be considered as a Machine Learning method). A novel single feature is extremely useful for simultaneous MIPs immobilization and state classification/physical MIPs state (bound, unbound) in a dispersed medium. The selection of the most relevant attributes for differentiating the several classes (MIP not bound to a target, MIP bound to a target, target alone) and the determination of the contribution weight of each original feature into the final one can reveal which parameters provide information about MIPs physical stage (present in the sample, bound/unbound to a target, e.g. a protein).

Thus, pretraining can be in the form of obtaining a single LDA variable correlated with the biochemical/biophysical state of the MIP (bound/unbound). This measure can then be monitored along time to detect if MIP is present and whether it is bound/not bound to the target, e.g. a molecule.

It is also disclosed a method for detecting a molecularly imprinted polymer (MIP), including detecting whether it is bound or not bound to a target analyte, in a liquid dispersion sample, said method using an electronic data processor for classifying the sample as having, or not having, said MIP present,
the method comprising the use of the electronic data processor for pre-training a machine learning classifier with a plurality of MIP specimens comprising specimens bound and specimens not bound to the target analyte, comprising the steps of:
   emitting a laser modulated by a modulation frequency onto each specimen;
   capturing a temporal signal from laser light backscattered or scattered forward by each specimen for a plurality of temporal periods of a predetermined duration for each specimen;
   calculating specimen coefficients from the captured signal for each of the temporal periods;
   using the calculated coefficients to pre-train the machine learning classifier;
wherein the method further comprises the steps of:
   using a laser emitter having a focusing optical system coupled to the emitter to emit a laser modulated by a modulation frequency onto the sample;
   using a light receiver to capture a signal from laser light backscattered or scattered forward by the sample for a plurality of temporal periods of a predetermined duration;
   calculating sample coefficients from the captured signal for each of the temporal periods;
   using the pre-trained machine learning classifier to classify the calculated sample coefficients as having, or not having, the MIP present and whether it is bound or not bound to a target analyte.

The molecularly imprinted polymer (MIP) may be trapped or dispersed (i.e. non-trapped) in a liquid dispersion sample.

The analyte may, for example, be a molecule, a protein, an enzyme, a hormone, an extracellular vesicle, a bacterium, a drug, an antibiotic or pesticide, among others.

In an embodiment, the electronic data processor is further arranged to classify, if present, the MIP into one of a plurality of MIP classes by using the machine learning classifier which has been pre-trained using a plurality of MIP liquid dispersion specimen classes.

The coefficients may be DCT or Wavelet transform coefficients. Alternatively, other transforms can be used such as Fourier or other characterization methods such as Principal Component Analysis in the Fourier domain.

In an embodiment, the laser is a visible light laser or an infrared laser or a combination, in particular an infrared laser, and the receiver is a visible light and infrared receiver.

In an embodiment, the laser is further modulated by one or more additional modulation frequencies. In an embodiment, the laser comprises a plurality of laser wavelengths.

In an embodiment, the specimen modulation frequency and the sample modulation frequency are identical.

In an embodiment, the specimen predetermined duration and the sample predetermined duration are identical.

In an embodiment, the captured plurality of temporal periods of a predetermined duration are obtained by splitting a captured temporal signal of a longer duration than the predetermined duration.

In an embodiment, the split temporal periods are overlapping temporal periods, or alternatively non-overlapping tumbling windows of, for example, 12 seconds.

In an embodiment, the predetermined temporal duration is selected from 1.5 to 2.5 seconds, in particular 2 seconds. Alternatively, shorter intervals like 500 ms can be used, for example the predetermined temporal duration can be selected from 0.5 to 1.5 seconds.

In an embodiment, the electronic data processor is further arranged to pre-train and classify using time domain histogram-derived or time domain statistics-derived features from the captured signal, in particular the features: wNakagami; μNakagami; entropy; standard deviation; or combinations thereof. Both linear and non-linear time domain-derived features can be obtained from the captured signal, in particular the features: root sum of squares level, area under the curve histogram, Petrosian fractal dimension, detrended fluctuation analysis coefficient can also be useful.

In an embodiment, the focusing optical system is a convergent lens.

In an embodiment, the focusing optical system is a convergent lens which is a polymeric photo-concentrator arranged at the tip of an optical fibre or waveguide.

In an embodiment, the focusing system is a convergent lens built in or attached to an optical fibre or waveguide.

In an embodiment, the focusing system is a converging lens built in or attached to an optical fibre/waveguide or a plane substrate.

In an embodiment, the focusing optical system is a focusing optical system suitable to provide a field gradient pattern, in particular a polymeric lens, fibre taper, amplitude or phase Fresnel plates, or any of the later with added gold film or films having a thickness and nano or micro holes or array of holes for plasmonic effects.

In an embodiment, the lens has a focusing spot corresponding to a beam waist of ⅓th to ¼th of a base diameter of the lens.

In an embodiment, the lens has a Numerical Aperture, NA, above 0.5. The numerical apertures (NA) values can range between 0.25 and 0.5 (values evaluated in a water medium). In an embodiment, the lens has a numerical aperture, NA, above 0.2 in air.

(Is best to present the values for air—easy to measure experimentally.)

In an embodiment, the lens has a base diameter of 5-10 μm, in particular 6-8 μm.

In an embodiment, the lens is spherical and has a length of 30-50 μm, in particular 37-47 μm.

In an embodiment, the lens has a curvature radius of 2-5 μm, in particular 2.5-3.5 μm or 1.5-3 μm.

In an embodiment, the infrared light receiver is a photoreceptor comprising a bandwidth of 400-1000 nm. Other bans are possible, for example, 1300-1600 nm.

In an embodiment, the calculation of transform coefficients comprises selecting a minimum subset of transform coefficients such that a predetermined percentage of the total energy of the signal is preserved by the transform.

In an embodiment, the number of the minimum subset of DCT transform coefficients is selected from 20 to 40, or from 20, 30 or 40.

In an embodiment, the signal capture is carried out at least with a sampling frequency of at least five times the modulation frequency. In an embodiment, the sampling frequency was effectively 10 times higher than the modulation frequency.

In an embodiment, the signal capture comprises a high-pass filter.

In an embodiment, the modulation frequency is equal or above 1 kHz. In another embodiment, the laser frequency is scanned over a frequency range.

In an embodiment, the MIPs have a particle size in any particle direction below 10 μm, or below 1 μm or between 10 nm and 10 μm.

It is also disclosed a non-transitory storage media including program instructions for implementing a method for detecting MIPs in a liquid dispersion sample, the program instructions including instructions executable by an electronic data processor to carry out the method of any of the disclosed embodiments.

Alternatively, instead to the DCT or Wavelet transform, both DCT and Wavelet transforms may be used, or another time series dimensionality-reduction transform may be used, or multiple time series dimensionality-reduction transforms may be used.

In an embodiment, the time series dimensionality-reduction transform is the discrete cosine transform, DCT.

In an embodiment, the time series dimensionality-reduction transform is the wavelet transform.

In an embodiment, the wavelet types are Haar and Daubechies (Db10), or Symlet wavelets.

Alternatively, dimensionality reduction was carried out using LDA itself, while the transform (for example, DCT) was used to calculate new features from the raw signal (augmenting dimensions) for machine-learning classification.

The disclosure may be explained by the distinct response of different types of MIP micro or nanoparticles to a highly focused electromagnetic potential. Two types of phenomena may then contribute for this distinct response among different types of nanostructures: its Brownian movement pattern in the liquid dispersion and/or its different optical polarizability, intrinsically correlated with its microscopic refractive index. Bound or unbound MIPs will have differentiated shape and refractive index structures, and therefore differentiated scattering signatures. MIP synthesis strategy can be used to tailor these changes and enhance detection. Therefore, Brownian movement pattern and/or optical polarizability are exposed by coefficients, in particular the DCT, wavelet- and spectral-derived parameters, extracted from the backscattering light, which are used by the said pre-trained machine learning classifier to classify MIPs, including said conversion to a single variable correlated to the presence/classification of MIPs. Alternatively, other transforms can be used such as Fourier or other characterization methods such as Principal Component Analysis in the Fourier domain, for example using fractional spectra (Fractional Bi-Spectrum).

In this case, the disclosure uses the distinctive time-dependent fluctuations in scattering intensity caused by constructive and destructive interference resulting from both relative Brownian movement of nanoparticles in the liquid dispersion, dictated by the particle diffusivity in the dispersion—parameter that only depends on particle size—and the response to the highly focused electromagnetic potential, that depends on the optical polarizability of the particle. The superposition of these two effects allows MIP distinction with the same size, which is not possible using the state-of-the-art light-scattering based methods.

The disclosure is applicable to MIP nanoparticles or micro-particles showing distinctive time-dependent fluctuations in scattering intensity caused by constructive and destructive interference resulting from relative Brownian movement of nanoparticles in the liquid dispersion sample affecting backscattered and/or forward scatter light and distinct optical polarizabilities (or microscopic refractive indexes).

The disclosure detects and identifies MIP nanoparticles with predetermined diameter, and/or refractive index, and/or optical polarizability.

### BRIEF DESCRIPTION OF THE DRAWINGS

The following figures provide preferred embodiments for illustrating the description and should not be seen as limiting the scope of invention.

FIG. 1: Schematic representation of a molecular imprinting process.

FIG. 2: Schematic representation of an optical setup for detecting and identifying MIPs and their binding state to target molecules, dispersed in a solution.

FIG. 3A: Schematic representation of a detailed setup for detecting and identifying MIPs and their binding state to target molecules, dispersed in a solution.

FIG. 3B: Schematic representation of a more detailed setup for detecting and identifying MIPs and their binding state to targets.

FIG. 4: Schematic representation of the signal processing flow according to an embodiment.

FIG. 5: Schematic representation according to an embodiment of how data can be split for training and testing, considering an example of an experiment including three classes of particles, wherein by “n” is intended to represent the number of evaluation runs/number of different combinations between train and test sets.

FIG. 6: Experimental results with the MIPs comparing the backscattered signal of the MIPs (before binding with target molecule), the target protein (P) and of the MIPs after binding with the protein (MIPs+P)

### DETAILED DESCRIPTION

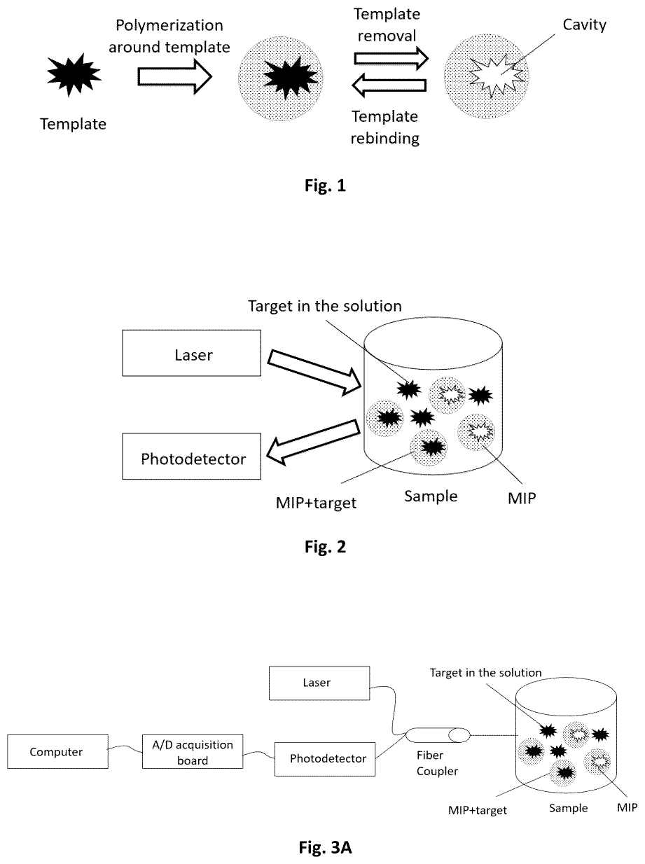

FIG. 1 discloses a schematic representation of a molecular imprinting process.

FIG. 2 discloses a schematic representation of an optical setup for detecting and identifying MIPs and their binding state to target molecules, dispersed in a solution.

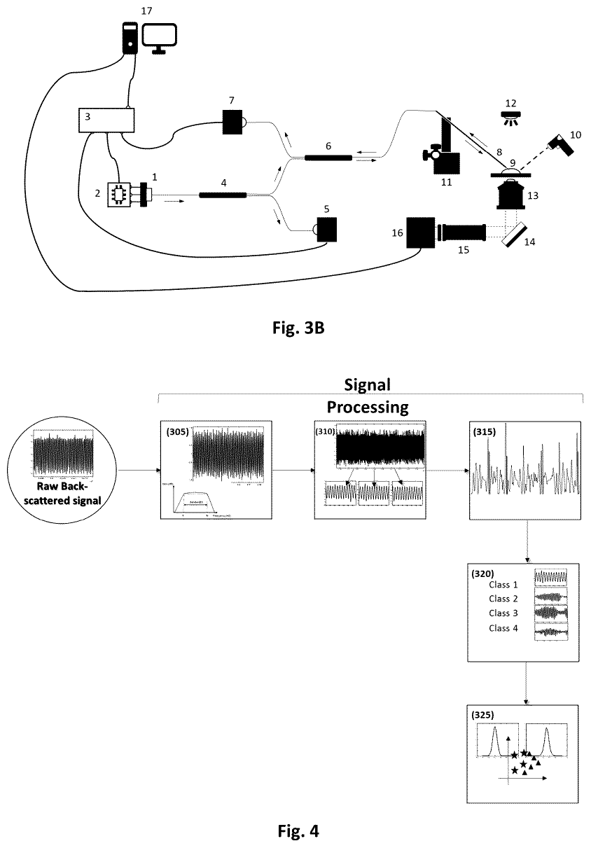

FIG. 3 discloses a schematic representation of a detailed setup for detecting and identifying MIPs and their binding state to target molecules, dispersed in a solution.

FIG. 3B shows a schematic representation of a more detailed setup for detecting and identifying MIPs and their binding state to targets. The irradiation laser (1: Lumentum Operations LLC, San Jose, CA, Catalog #S28-7602-500), emitting at 976 nm wavelength, was modulated in frequency by a sinusoidal signal (fundamental frequency of 1 kHz, to escape from the electrical grid 50 Hz harmonics) digitally generated at a sampling rate of 10 kHz using a custom-build MATLAB script according to the equation:1.45+0.045*sin(2*π*1000*t), t—time in seconds, so that, considering the laser driver's gain, the laser characteristic curve, and the optical loss along the fibre components, the lens' output optical power was 40 mW. This value was determined in accordance with the values used in the literature for optical delivery, collection and manipulation effects through optical fibres considering the selected wavelength value range, and to cause as little damage as possible to the biological human-derived samples [28]. The modulation signal was externally injected into the laser driver (2: MWTechnologies Lda, Portugal, Model #cLDD) through one of the output digital-to-analog ports of the data acquisition board (3: NI, Austin, TX, Model #USB-6212 BNC). The resulting optical signal, mirroring the modulation equation, is inserted into the optical fibre and passes through a 1/99 optical coupler (4: Laser Components GmbH, Germany, Model #3044214). While most of the radiation follows to the rest of the optical circuit, 1% of the radiation is monitored using a silicon photodetector (5: Thorlabs Inc, Newton, NJ, Model #PDA-32A2) connected to one DAQ analog-input port. A 50/50, 1×2, optical coupler (6: AFW Technologies Pty Ltd, Australia, Model #FOSC-1-98-50-L-1-H64F-2) establishes a bidirectional connection between the incoming light from the laser module, the sensing photodetector (7: Thorlabs Inc, Newton, NJ, Model #PDA-32A2) and the sensing probe (8: the microlensed optical fibre with its end just outside a metal capillary). This allows the probe to simultaneously focus the light coming from the laser and the collection of the back-scattered radiation arising from the liquid dispersion sample (9) to be analysed. To provide further information about the samples' conditions/properties, temperature readings are obtained using an Infrared Thermometer (10: Axiomet, Poland, Model #AX-7600). (Please note that the same result could also be achieved using other optical components. Instead of the coupler, a circulator, or another kind of coupler configuration could be used to achieve the same—or even better—results). The sensing probe is manipulated using a 4 axis (x, y, z, and tilt) right-hand micromanipulator (11: Siskiyou Corporation, Grants Pass, OR, Model #:MX7600) with a probe holder where the capillary is fixed. This manipulator is connected to a closed-loop dial controller (Siskiyou Corporation, Grants Pass, OR, Model #:MC1000e-R1/4T) that allows a more precise displacement of the probe into and inside the sample. The visualization and imaging module is composed by a self-made inverted microscope setup using a standard white LED light source (12), an objective (13, currently at 20×, but higher amplification can be used to observe smaller particles), a mirror (14) and a zoom lens (15: Edmund Optics, Barrington, NJ, Model #VZM 450). This microscope drives the desired imaging plane to a digital camera (Edmund Optics, Barrington, NJ, USA Model EO-1312C #Catalog 83-770). The image is observed in real-time in the lab's computer (17) using IDS:'s software uEye Cockpit. The camera's sensing region allows for the visualization of the focused infrared beam and its reaction with the sample's constituents.

According to another example an optical setup is also used. A pigtailed 980 nm laser (500 mW, Lumics, ref. LU0980M500) was included in the optical setup. A 50/50 fibre coupler with a 1×2 topology is used for connecting two inputs—the laser and the photodetector (back-scattered signal acquisition module). The optical fibre tip was then spliced to the output of the fibre coupler and inserted into a metallic capillary controlled by the motorized micromanipulator. This configuration allowed both laser light guidance to the optical fibre tip through the optical fibre and the acquisition of the back-scattered signal through a photodetector (PDA 36A-EC, Thorlabs). In addition to the photodetector, the back-scattered signal acquisition module was also composed by an analog-to-digital acquisition board (National Instruments DAQ), which was connected to the photodetector for transmitting the acquired signal to the laptop where it is stored for further processing. A digital-to-analog output of the DAQ was also connected to the laser for modulating its signal using a sinusoidal signal with a fundamental frequency of 1 KHz. A liquid sample is loaded over a glass coverslip and a fibre with the photoconcentrator on its extremity is inserted into the sample.

A photo-concentrator is preferably used and consists in a polymeric lens fabricated through a guided wave photopolymerization method. This photo-concentrator is characterized by a converging spherical lens with a NA>0.5, or 2.5<NA<5, able to focus the laser beam onto a highly focused spot corresponding to a beam waist of about ⅓-¼th of the base diameter of the lens. Additionally, a base diameter between 6-8 μm and a curvature radius between 2-3.5 μm is also a suitable solution. The fibre tip with the photoconcentrator is immersed into the liquid sample and the back-scattered signal is acquired considering different locations of the tip in the solution.

Reference is made to FIG. 4 to explain signal acquisition and processing according to an example. Back-scattered raw signal was acquired through a photodetector (PDA 36A-EC, Thorlabs) connected to an Analog-to-Digital converter (National Instruments DAQ) at a sampling rate of 5 kHz for all the Experiments (I-VII), or above 5 kHz, or 10 kHz. After each acquisition, the original signal was passed through processing steps. During signal processing, the signal was at first filtered, using a second-order 500 Hz Butterworth high-pass filter (305), since the input irradiation laser was modulated using a 1 kHz sinusoidal signal, and to remove noisy low-frequency components of the acquired signal (e.g. 50 Hz electrical grid component). Then, the entire signal acquired for each particle and condition is split into epochs of 2 seconds (310) or, for example, 0.5 seconds, or for example non-overlapping temporal periods of tumbling windows of 12 seconds. The z-score of each signal portion is computed in order to remove noisy signal epochs (315). Z-scored signal portions which, in magnitude, exceeded the threshold value between 5-10 are removed (315). After these steps, it was possible to obtain a dataset with signal portions with a reasonable Signal to Noise Ratio (SNR) for the MIP class identification to be possible (320).

In an exemplary implementation, a total of 54 features were extracted (FIG. 4, 325) from the back-scattered signal to characterize each class that could be separated in two main types: time-domain and frequency-domain features. The first set can be divided into two subsets: time-domain statistics and time-domain histogram-derived features. The frequency-domain set is also divided into two groups: Discrete Cosine Transform (DCT)-derived features and Wavelet features. The 54 features considered according to an exemplary embodiment are listed in table 2. Time-derived features as used herein comprise time-domain metrics and non-linear measures. While time-domain metrics provide information on distinct statistical aspects of the signal, non-linear measures describe the complexity and regularity of the signal. On the other hand, frequency-related features can be subdivided into wavelet-derived, DCT-derived, and spectral. Altogether, these features capture the behaviour of the signal in different frequency bands.

The following time-domain statistics features are extracted from each 2-seconds signal portion: Standard Deviation (SD), Root Mean Square (RMS), Skewness (Skew), Kurtosis (Kurt), Interquartile Range (IQR), Entropy (E), considering its adequacy in differentiating with statistical significance synthetic particles from different types. Considering that the Nakagami distribution have been widely used to describe the back-scattered echo in statistical terms, mainly within the Biomedical area, the Probability Density Function (PDF)-derived μ_{Nakagami} and ω_{Nakagami} parameters that better fit the approximation of each 2-seconds signal portion distribution to the Nakagami distribution are also considered. These were the time-domain histogram-derived parameters considered in the classification. In total, eight features obtained through time-domain analysis of the back-scattered signal are used by the proposed method. Considering the ability to capture minimal periodicities of the analysed signal, the associated coefficients being uncorrelated and due to the fact, in contrast to the Fast Fourier Transform (FFT), it does not inject high frequency artefacts in the transformed data, the Discrete Cosine Transform (DCT) is applied to the original short-term signal portions to extract frequency-derived information. Considering that the first n coefficients of the DCT of the scattering echo signal are defined by the following equation:

$${E}_{i}^{DCT} [ l ] = {\sum }_{k = 0}^{N - 1} {ε}_{i} [ k ] cos [ \frac{π l ( 2 k + 1 )}{2 N} ] , \\ for l = 1 … , n , \qquad ( 1 )$$

in which εᵢ is signal envelope estimated using the Hilbert transform; by sorting the DCT coefficients from the highest to the lowest value of magnitude and obtaining the following vector:

$${y}_{i} = {( {E}_{i}^{D C T} , … , {E}_{i}^{D C T} [ {l}^{n} ] )}^{T} , \qquad ( 2 )$$

in which E^{DCT}ᵢ[I¹] represents the highest DCT coefficient in magnitude, it is possible to determine the percentage of the total amount of the signal energy that each set of coefficients represent (organized from the highest to the lowest one). Each percentage value regarding each set of coefficients (from the first to the nth coefficient) can be obtained by dividing the norm of the vector formed by the first till the nth coefficient by the norm of the vector composed by all the n coefficients. Thus, the following DCT-derived features are used for characterizing each 2 s signal portion: the number of coefficients needed to represent about 98% of the total energy of the original signal (N_{DCT}), the first 20, 30 or 40 DCT coefficients extracted from the vector defined in (2), the Area Under the Curve (AUC) of the DCT spectrum for all the frequencies (from 0 to 2.5 kHz) (AUC_{DCT}), the maximum amplitude of the DCT spectrum (Peak_{DCT}) and the signal power spectrum obtained through the DCT considering all the values within the frequency range analysed (from 0 to 2.5 kHz) (P_{DCT})—please consult Table 1.

The remaining 12 features were extracted after 2-seconds signal portion decomposition using wavelets²¹ (consult table 1). Two mother wavelets—Haar and Daubechies (Db10)—are selected to characterize each back-scattered signal portion. Six features for each type of mother Wavelet based on the relative power of the Wavelet packet-derived reconstructed signal (one to six levels) are therefore extracted from each short-term 2-second signal.

The disclosure is able to detect and identify different types of MIPs because extracts frequency derived features (that is, spectral-derived features) from the backscattering signal that are sensitive to particle's dimension, optical polarizability and microscopic refractive index.

As stated in Equation 3, nanoparticles motion is influenced by both the diffusivity D and the response of the particle to the optical potential that is exerted on it by the highly focused electromagnetic field. Therefore, the variability of the particle position along time is given by the Equation 3:

$$σ ( t ) = \frac{{k}_{B} T}{{k}_{potential}} [ 1 - {e}^{( - \frac{2 {k}_{potential} Dt}{{k}_{B} T} )} ] \qquad ( 3 )$$

Where kₚₒₜₑₙₜᵢₐₗ determines the response of the particle to the optical potential and depends on the particle polarizability α, which is presented in equation 4:

$${k}_{potential} = ( \frac{2 π}{c} ∇ I ) α \cdot \frac{1}{x}$$

Where ∇I represents the gradient of the electromagnetic field over 1D and x is the coordinate of given point in 1D subjected to the forces exerted by the applied electromagnetic field. The particle polarizability α is defined as:

$$α = {n}_{m}^{2} {r}^{3} ( \frac{\frac{{n}_{p}^{2}}{{n}_{m}} - 1}{\frac{{n}_{p}^{2}}{{n}_{m}} + 2} ) \qquad ( 4 )$$

Where nₚ is the microscopic refractive index of the particle and nm is the refractive index of the media.

Equations 3 and 4 contrast with the “simpler” formulation used to describe the Brownian motion of nanoparticles in state-of-art methods (e.g. dynamic light scattering), which solely depends on the diffusivity D of the particle within the dispersion. This simple Brownian motion is given by the variability of the particle position along time (σ(t)):

$$σ ( t ) = 2 Dt . \qquad ( 5 )$$

$$and D :$$

$$D = \frac{{k}_{B} T}{6 π η r} \qquad ( 6 )$$

where k_{B} is the Boltzmann constant, T is the absolute temperature, η is the viscosity of the fluid and r is the radius of the particle. Thus, this mathematical formulation of the Brownian motion states that the particle position along time (σ(t)) just depends on nanoparticles' radius.

A classification algorithm can be used to detect/classify MIPs in liquid samples, namely a Random Forests classifier. Alternatively, as disclosed, a LDA-obtained single-feature variable may also be used.

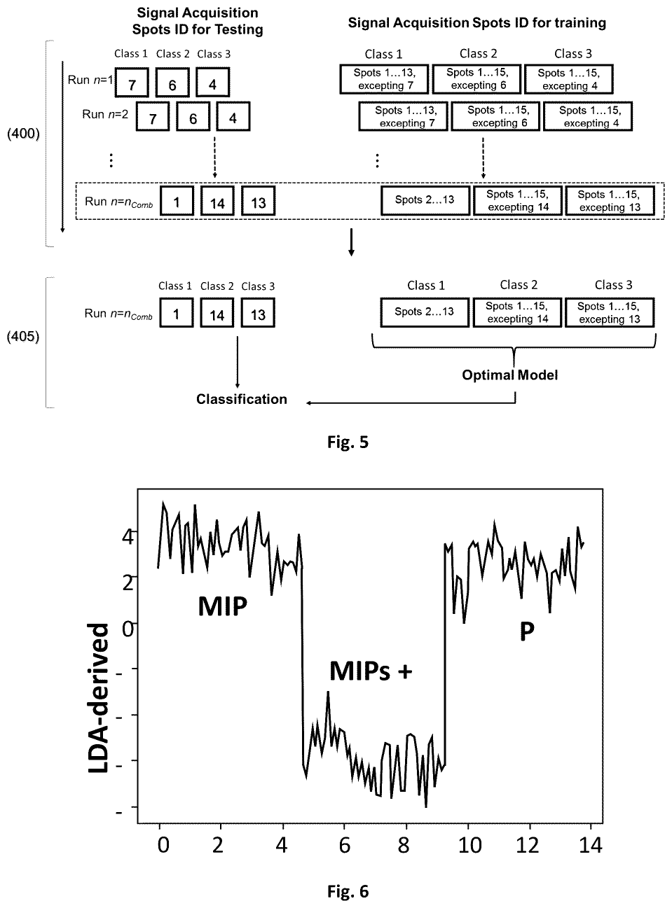

Reference to FIG. 5 is made to explain the Leave-One-Out procedure (400), that was performed to ensure that the data used for evaluating the performance of a classifier belongs to a subject/entity who was never involved in the training. Thus, if a dataset is composed by data from n subjects/entities, the test set is divided in n testing rounds, in which, in each round, the data from a subject are used for test and the data from the remaining n−1 subjects are used for classifier training. In the next round, the data subset from another subject that was selected for training in the previous round is used separately for testing the classifier. Then, the classifier performance is determined based on the mean values obtained after the n testing rounds.

The above mentioned method and device was used in experiments designed not to individualize a specific particle and identify it, but instead to detect the presence of a given type of nanoparticles in solution. The factor that differentiated the signal portions acquired during experiments involving nanoparticles and microparticles was the place where they were taken between acquisitions. Thus, signal portions used for test were acquired at different locations from the ones considered for training during the Experiments with nanoparticles, a way to avoid overfitting effects. Note that, in these cases, it was not possible to individualize particles due to their nanoscale dimensions and the inability of our fibre tools to trap them.

The most accurate classification rate for each one of the Experiments/Problems and nth evaluation run was obtained by determining the most suitable combination of values between the three parameters (FIG. 5; 405): number of trees, number of predictors to sample and minimum leaf size—please consult table 1. This combination, therefore, produces a classifier trained considering that combination of values (FIG. 5, 405). The most effective combination of these parameters was then determined using five-fold cross-validation (FIG. 5, 405), for each Experiment and evaluation run, during the training phase. However, training samples were normalized. Training samples mean value across each feature was subtracted to each data sample from that feature, and then divided by the corresponding feature standard deviation. Test input samples must be normalized also according to this procedure, using the previously obtained training mean and standard deviation for each feature. This allows to map the novel test features vectors in the training features space.

TABLE 1
List of parameters tuned during classifier
training stage for model optimization.
Training Parameters

| | |
|---|---|
| Nr. of Trees | 5, 20, 30, 40, 50, |
| | 60, 70, 80, 90, 100 |
| Min. Leaf Size | 3, 5, 7 |
| Nr. Predictors To Sample | 5, 7, 9, 11, 13, 15 |
| Nr. of Optimization Runs | 10 × 3 × 6 = 180 |

Nr.—Number. Min.—Minimum.

TABLE 2
List of 54 back-scattered signal features/parameters
set to detect and differentiate particle classes.

| Type | Group | Number | Feature/Parameter |
|---|---|---|---|
| Time | Time Domain | 1 | Standard Deviation (SD) |
| Domain | Statistics | 2 | Root Mean Square (RMS) |
| | | 3 | Skewness (Skew) |
| | | 4 | Kurtosis (Kurt) |
| | | 5 | Interquartile Range (IQR) |
| | | 6 | Entropy (E) |
| | Time Domain | 7 | μ_{Nakagami} |
| | Histogram | 8 | ω_{Nakagami} |
| Frequency | Discrete Cosine | 8 | 1st Coefficient (E_{DCT}[l¹]) |
| Domain | Transform (DCT) | 10 | 2nd Coefficient (E_{DCT}[l²]) |
| | | 11 | 3rd Coefficient (E_{DCT}[l³]) |
| | | 12 | 4th Coefficient (E_{DCT}[l⁴]) |
| | | 13 | 5th Coefficient (E_{DCT}[l⁵]) |
| | | 14 | 6th Coefficient (E_{DCT}[l⁶]) |
| | | 15 | 7th Coefficient (E_{DCT}[l⁷]) |
| | | 16 | 8th Coefficient (E_{DCT}[l⁸]) |
| | | 17 | 9th Coefficient (E_{DCT}[l⁹]) |
| | | 18 | 10th Coefficient (E_{DCT}[l¹⁰]) |
| | | 19 | 11th Coefficient (E_{DCT}[l¹¹]) |
| | | 20 | 12th Coefficient (E_{DCT}[l¹²]) |
| | | 21 | 13th Coefficient (E_{DCT}[l¹³]) |
| | | 22 | 14th Coefficient (E_{DCT}[l¹⁴]) |
| | | 23 | 15th Coefficient (E_{DCT}[l¹⁵]) |
| | | 24 | 16th Coefficient (E_{DCT}[l¹⁶]) |
| | | 25 | 17th Coefficient (E_{DCT}[l¹⁷]) |
| | | 26 | 18th Coefficient (E_{DCT}[l¹⁸]) |
| | | 27 | 19th Coefficient (E_{DCT}[l¹⁹]) |
| | | 28 | 20th Coefficient (E_{DCT}[l²⁰]) |
| | | 29 | 21st Coefficient (E_{DCT}[l²¹]) |
| | | 30 | 22nd Coefficient (E_{DCT}[l²²]) |
| | | 31 | 23rd Coefficient (E_{DCT}[l²³]) |
| | | 32 | 24th Coefficient (E_{DCT}[l²⁴]) |
| | | 33 | 25th Coefficient (E_{DCT}[l²⁵]) |
| | | 34 | 26th Coefficient (E_{DCT}[l²⁶]) |
| | | 35 | 27th Coefficient (E_{DCT}[l²⁷]) |
| | | 36 | 28th Coefficient (E_{DCT}[l²⁸]) |
| | | 37 | 29th Coefficient (E_{DCT}[l²⁹]) |
| | | 38 | 30th Coefficient (E_{DCT}[l³⁰]) |
| | | 39 | Number of coefficients that capture |
| | | | 98% of the original signal (N_{DCT}) |
| | | 40 | Total spectrum Area Under Curve (AUC) (AUC_{DCT}) |
| | | 41 | Maximum peak amplitude (Peak_{DCT}) |
| | | 42 | Total spectral power (P_{DCT}) |
| | Wavelet Packet | 43 | Haar Relative Power 1st level (E_{Haar}¹) |
| | Decomposition | 44 | Haar Relative Power 2nd level (E_{Haar}²) |
| | | 45 | Haar Relative Power 3rd level (E_{Haar}³) |
| | | 46 | Haar Relative Power 4th level (E_{Haar}⁴) |
| | | 47 | Haar Relative Power 5th level (E_{Haar}⁵) |
| | | 48 | Haar Relative Power 6th level (E_{Haar}⁶) |
| | | 49 | Db10 Relative Power 1st level (E_{Db10}¹) |
| | | 50 | Db10 Relative Power 2nd level (E_{Db10}²) |
| | | 51 | Db10 Relative Power 3rd level (E_{Db10}³) |
| | | 52 | Db10 Relative Power 4th level (E_{Db10}⁴) |
| | | 53 | Db10 Relative Power 5th level (E_{Db10}⁵) |
| | | 54 | Db10 Relative Power 6th level (E_{Db10}⁶) |

In another example, in order to demonstrate the differentiating ability of a single feature derived from LDA regarding MIPs presence and corresponding binding to targets in a dispersion, statistical tests were conducted. Non-parametric statistical tests were applied, due to the fact that some of the features analysed failed to be normally distributed (Shapiro-Wilk Normality Test). Statistical evaluation was conducted using the Python's scipy library. The potential for differentiating in a 3 class (target, target bound to MIP, and MIP not bound to target), or in a pairwise manner of the single feature variable created using LDA was evaluated using the Kruskal-Wallis (4 conditions) and Mann-Whitney (2 conditions) statistical tests, respectively. The statistical significance level of 0.05 was considered for all the statistical tests conducted.

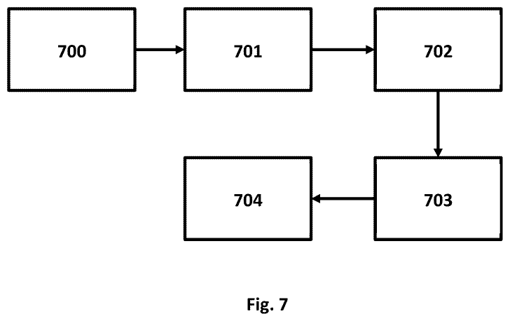

In FIG. 6 is shown the experimental result using the aforementioned system to detect and identify Transferrin in a liquid dispersion sample. Briefly, three diluted samples in human serum (1:1000) were prepared: (1) containing Transferrin (sample P); (2) containing the MIP (sample MIPs), and; (3) 10 uL of Sample P was diluted in 990 uL of sample MIPs and was left to incubate at room temperature (sample MIPs+P).

Afterwards, the optical setup was used to acquire the data from the samples, which was further analysed using Linear Discriminant Analysis (LDA). It is worth noting that others statistical analysis could have been used to evaluate the dataset. As one can see in FIG. 6, there is a signal enhancement of about 10 a.u (y axis) when the signal obtained from the sample containing only the MIPs is compared to the sample in which the Transferrin is bounded to the MIPs, which is statistically significant.

The signal enhancement is possible because during the MIP synthesis was given, by design, a strong recognizable scattering signature (fingerprint). Since the fingerprint depends on several factors such as on the size, optical properties of the particles and optical gradients, its signature changes when the target analyte bounds to the MIPs, thus potentially allowing our scattering analysis methods to robustly address the identification of selected analytes in complex matrixes. Deformable of MIPs are advantageous in that there is a strong recognizable scattering signature.

FIG. 7 shows the particular embodiment where machine-learning is carried out using LDA. The raw data 700 is pre-processed 701, for example by noise removal, using a high-pass filter (500 Hz) and/or a band-stop filter. Feature extraction 702 is carried out. Usually, a high number of features is desirable (e.g. 98 features in an embodiment). Then, these are projected into a single feature using Linear Discriminant Analysis 703, finding a projection hyperplane that minimizes interclass variance and maximises the distance between classes mean. Finally, the obtained feature is subject to statistical analysis 704, for example non-parametric test like Kruskal-Wallis test or Mann-Whitney test to assess the results provided by the obtained feature.

Optical trapping is a mean to trap and manipulate particles, in the nano to micrometre sized range, in a contactless and stable way. The trapping effect can be obtained using two counter propagating beams or a single and highly focused laser beam. The latter is also known as optical tweezers.

Conventional optical tweezers setups comprise a laser source (trapping laser), optical components to expand and steer the beam, a microscope objective, condenser, a position detector (beam displacement measurement), an observation system (e.g. CCD camera) and a sample holder. Optical tweezer setups normally include a quadrant photodetector or the like, as a position sensor.

Scattering and gradient forces play the major role in optical trapping. While the scattering force is proportional to the intensity of the electric field and pushes the particle away from the laser beam, the gradient force is proportional to the gradient of the electric field and redirects the particle towards the highest intensity region. These optical forces (piconewton) depend on the ratio of the particle radius and the laser wavelength.

In the case of the two counter propagating beams, the stable trapping effect is achieved when a balance between the axial scattering forces of the two beams is obtained. On the other hand, for a single beam trapping the stable trapping effect is obtained when the gradient force exceeds the scattering one, establishing conditions for attractive forces and zones of zero net force to arise. When gradient forces prevail, 3-dimentional (3-D) stable trapping can be obtained.

Several fabrication techniques can be used to obtain optical fibre tweezers, such as polishing, chemical etching, thermal pulling, focused ion-beam milling, femtosecond laser and photo-polymerization to name a few.

The list of signal features used can vary. For example, Table 3 shows a set of features usable in the present disclosure to detect targets and differentiate particle target.

TABLE 3
List of signal features/parameters set to
detect and differentiate particle classes.

| Type | Group | Feature |
|---|---|---|
| Time- | Time | Standard Deviation |
| domain | domain | Interquartile range |
| | metrics | Kurtosis |
| | | Skewness |
| | | Mean |
| | | Root mean square |
| | | Signal power |
| | | Entropy |
| | | Root sum of squares level |
| | | Area under the curve histogram |
| | Non- | Approximate entropy |
| | linear | Singular value decomposition entropy |
| | | Petrosian fractal dimension |
| | | Higuchi fractal dimension |
| | | Detrended fluctuation analysis coefficient |
| | | Hurst Exponent |
| | | Hjorth complexity |
| | | Hjorth mobility |
| Frequency- | DCT- | 1^{st}-30^{th} DCT coefficient |
| domain | derived | Number of DCT coefficients that capture |
| | | 98% of the original signal |
| | | Total spectrum Area Under Curve |
| | | Spectral Entropy |
| | | 1^{st}-10^{th} Hilbert peak |
| | | Number of Hilbert coefficients that capture |
| | | 98% of the original signal |
| | | Haar Relative Power 1^{st} level-6^{th} level |
| | | Db10 Relative Power 1^{st} level-6^{th} level |
| | | Symlet Relative Power 2^{nd} level-6^{th} level |
| | | Db4 Relative Power 2^{nd} level-6^{th} level |
| | Spectral | Spectral contrast std |
| | | Spectral contrast mean |
| | | Spectral contrast max |
| | | Spectral roll-off frequency std |
| | | Spectral roll-off frequency mean |
| | | Spectral roll-off frequency max |
| | | Spectral flatness std |
| | | Spectral flatness mean |
| | | Spectra flatness max |
| | | Spectral centroid std |
| | | Spectral centroid mean |
| | | Spectral centroid max |

The following describes Time domain linear features in more detail.

Time domain metrics such as mean, standard deviation, root mean square, signal power, root sum of squares level (RSSQ), skewness, kurtosis, interquartile range and entropy were used, given its adequacy in differentiating types of periodic signals.

For instance, skewness reflects the distribution symmetry degree, while kurtosis quantifies whether the shape of the data distribution matches the Gaussian distribution. Both have been widely used in several signal processing approaches, for quantifying how far, in statistical terms, the evaluated sample distribution is from a normal one.

The following describes Time domain non-linear features in more detail.

Non-linear features are useful to describe the complexity and regularity of a signal and are often used to describe the phase behaviour of predominantly stochastic signals, such as EEG. A total of 8 non-linear features were considered: approximate entropy, singular value decomposition (SVD) entropy, Petrosian fractal dimension, Hurst exponent, Detrended fluctuation analysis (DFA), Higuchi fractal dimension, Hjorth complexity and mobility.

Approximate entropy—Approximate entropy is an indicator of the complexity of the time series. This technique quantifies the amount of regularity and the unpredictability of fluctuations over time-series data.

Singular value decomposition entropy—SVD entropy is an indicator of the number of eigenvectors that are needed for an adequate explanation of the data set. In other words, it measures the dimensionality of the data.

A fractal dimension is a ratio providing a statistical index of complexity comparing how detail in a pattern changes with the scale at which it is measured. It has also been characterized as a measure of the space-filling capacity of a pattern that tells how a fractal scales differently from the space it is embedded in; a fractal dimension does not have to be an integer. It is a highly sensitive measure for the detection of hidden information contained in physiological time series, because it performs well on turbulent and irregular time series.

Petrosian fractal dimension—Petrosian's algorithm provides a fast computation of the fractal dimension of a signal by translating the series into a binary sequence.

Higuchi fractal dimension—Higuchi is an algorithm for measuring fractal dimension of time series and is used to quantify complexity and self-similarity of signal. Higuchi's fractal dimension originates from chaos theory and for almost thirty years it has been successfully applied as a complexity measure of artificial, natural, or physiological signals. Higuchi's method has proven to be a good numerical approach for rapid assessment of signal nonlinearity and it may encompass all information about the dynamic data generation process.

Detrended fluctuation analysis coefficient—DFA is a method for quantifying fractal scaling and correlation properties in the signal. The main advantage of this method is that it distinguishes intrinsic fluctuation generated by the system from that caused externally.

Hurst exponent—The Hurst exponent measures the “long-term memory” of a time series. It can be used to determine whether the time series is more, less, or equally likely to increase if it has increased in previous steps.

Hjorth complexity & Hjorth mobility—Bo Hjorth proposed a mathematical method to describe an EEG trace quantitatively, which has been widely applied to various EEG-based problems. The mobility parameter is the square root of the ratio between the variance of the first derivative and the variance of the signal. The complexity parameter represents the changes of the signal frequencies. The Hjorth complexity is the ratio between the Hjorth mobility of the first derivative of the signal and the Hjorth mobility of the signal. This parameter is dimensionless and, due to the non-linear calculation of standard deviation, quantifies any deviation from the sine shape. The value converges to 1 if the signal is more similar.

The following describes Frequency transform-domain features in more detail.

Regarding the frequency-domain analysis of the back-scattered signal, three sets of features can be extracted in the present disclosure: Discrete Cosine Transform (DCT) parameters, Wavelet derived coefficients and spectral features.

Discrete Cosine Transform—The DCT, applied to each epoch of the back-scattered signal, captures minimal periodicities of the signal, without injecting high-frequency artifacts in the transformed data. Besides being highly adequate to short signals, it is highly attractive for this type of problems which require to differentiate target classes, because DCT coefficients are uncorrelated. Thus, they can be used as suitable features for characterizing each peptide class. Additionally, the DCT is able to embed most of the signal energy into a small number of coefficients. The first n coefficients of the DCT of the scattering echo signal are defined by the following equation:

$${E}_{DCTi} [ l ] = Σ N - 1 k = 0 ε i [ k ] cos cos [ π l ( 2 k + 1 ) 2 N ] … , for l = 1 , … , n$$

where εᵢ is the signal envelope estimated using the Hilbert transform. The following features were extracted from DCT analysis: the number of coefficients needed to represent about 98% of the total energy of the original signal, the first 30 DCT coefficients, the Area Under the Curve (AUC) of the DCT spectrum for all the frequencies before the modulation frequency (1 kHz) and, the entropy of the DCT spectrum.

Hilbert Transform—A similar analysis to the DCT transform was conducted using the Hilbert transform. When applied to the signal, the Hilbert transform produces its analytical real-valued representation. The 10 highest amplitude peaks of the Hilbert transformed signal were used as features, as well as the number of coefficients needed to represent about 98% of the total energy of the original signal. The first Hilbert coefficient corresponds to the highest peak in the analytic signal and can give important information about the phase of the signal.

Wavelet Transform—By applying wavelet packet decomposition, it is possible to extract, in each frequency band, certain tonal information from the original signal depending on the frequency range and content of the back-scattered signal. To achieve this, a suitable mother Wavelet is chosen to be used as a prototype to be compared with the original signal and extract frequency subband information. Four mother Wavelets—Haar, Daubechies (Db10 and Db4) and Symlet—were selected to characterize the back-scattered signal portions. The Haar wavelet was selected due to its simplicity and computational speed; the Daubechies wavelets display a better approximation of smooth functions; and, the Symlet wavelets have been used to decompose the signal into five time-frequency subbands to recognize epileptic EEG states. This feature can reduce the phase distortion in the analysis.

The following describes Frequency spectral-domains features in more detail.

Spectral features characterize the power spectrum of the signal, i.e., the distribution of power across the frequency components composing that signal. It is obtained using the Fourier Transform. Four measures were derived from the spectrum: spectral flatness, spectral centroid, spectral contrast, and spectral roll-off. A total of 12 features were calculated from these measures.

Spectral contrast—Spectral contrast is defined as the difference between valleys and peaks that compose the spectrum. The spectrogram is divided into sub-bands. For each sub-band, the energy contrast is estimated by comparing the mean energy in the top quantile (peak energy) to that of the bottom quantile (valley energy). High contrast values generally correspond to clear, narrow-band signals, while low contrast values correspond to broad-band noise. Three features were derived from this measure: the mean, the maximum, and the standard deviation of the spectral contrast.

Spectral roll-off frequency—The roll-off frequency characterizes the inclination of the signal's spectrum. This feature is defined as the centre frequency for a spectrogram bin such that at least 85% of the energy of the spectrum is contained in this bin and the bins below. Three features were computed using this measure: the mean, the maximum and the standard deviation of the spectral roll off frequencies.

Spectral flatness—Spectral flatness quantifies how tone-like a signal is, as opposed to being a noise-like signal. A high spectral flatness (closer to 1.0) indicates the spectrum is similar to white noise. Three features were calculated using this measure: the mean, the maximum and the standard deviation of the spectral flatness.

Spectral centroid—The spectral centroid indicates the location of the centre of mass of each frequency bin in the spectrogram. For each one of these measures three features were calculated: the mean, the maximum and the standard deviation.

The term “comprising” whenever used in this document is intended to indicate the presence of stated features, integers, steps, components, but not to preclude the presence or addition of one or more other features, integers, steps, components or groups thereof. The disclosure should not be seen in any way restricted to the embodiments described and a person with ordinary skill in the art will foresee many possibilities to modifications thereof. The above described embodiments are combinable. The following claims further set out particular embodiments of the disclosure.

1. A method for detecting a molecularly imprinted polymer (MIP) from a backscattered or scattered forward light fingerprint, including detecting whether it is bound or not bound to a target analyte, in a liquid dispersion sample, said method using an electronic data processor for classifying the sample as having, or not having, said MIP present, the method comprising the use of the electronic data processor for pre-training a machine learning classifier with a plurality of MIP specimens comprising specimens bound and specimens not bound to the target analyte, comprising the steps of:
emitting a laser modulated by a modulation frequency onto each specimen;
capturing a temporal signal from laser light backscattered or scattered forward by each specimen for a plurality of temporal periods of a predetermined duration for each specimen;
calculating specimen coefficients from the captured signal for each of the temporal periods;
using the calculated coefficients to pre-train the machine learning classifier;
wherein the method further comprises the steps of:
using a laser emitter having a focusing optical system coupled to the emitter to emit a laser modulated by a modulation frequency onto the sample;
using a light receiver to capture a signal from laser light backscattered or scattered forward by the sample for a plurality of temporal periods of a predetermined duration;
calculating sample coefficients from the captured signal for each of the temporal periods;
using the pre-trained machine learning classifier to classify the calculated sample coefficients as having, or not having, the MIP present and whether it is bound or not bound to a target analyte.

2. The method of claim 1, wherein the MIPs have a particle size, in any particle direction, below 1 μm.

3. The method of claim 2, further comprising the electronic data processor classifying, if present, the MIP into one of a plurality of MIP classes by using the machine learning classifier which has been pre-trained using a plurality of MIP liquid dispersion specimen classes.

4. The method of claim 3, further comprising the electronic data processor classifying, if present, each of the plurality of MIPs into one of a plurality of MIP classes by using the machine learning classifier which has been pre-trained using a plurality of MIP liquid dispersion specimen classes.

5. The method of claim 1, wherein the machine learning classifier is obtained by Linear Discriminant Analysis (LDA), in particular a single-feature variable obtained by Linear Discriminant Analysis (LDA).

6. The method of claim 1, wherein the MIP to be identified is trapped or dispersed, non-trapped, in the liquid dispersion sample.

7. The method of claim 1, wherein the analyte is a molecule, a protein, an enzyme, a hormone, an extracellular vesicle, a bacterium, a drug, an antibiotic or a pesticide.

8. (canceled)

9. The method of claim 1, wherein the laser is further modulated by one or more additional modulation frequencies or the laser comprises a plurality of laser wavelengths.

10. The method of claim 1, wherein the specimen modulation frequency and the sample modulation frequency are identical.

11. The method of claim 1, wherein the specimen predetermined duration and the sample predetermined duration are identical.

12. The method of claim 1, wherein the captured plurality of temporal periods of a predetermined duration are obtained by splitting a captured temporal signal of a longer duration than the predetermined duration.

13. (canceled)

14. The method of claim 1, wherein the predetermined temporal duration is from 1.5 to 2.5 seconds, or from 0.5 to 1.5 seconds.

15. The method of claim 1, wherein the electronic data processor is further arranged to pre-train and classify using time domain histogram-derived or time domain statistics-derived features from the captured signal, in particular the features: w_{Nakagami}; μ_{Nakagami}; entropy; standard deviation; or linear and/or non-linear time domain-derived features from the captured signal, in particular the features: root sum of squares level, area under the curve histogram, Petrosian fractal dimension, detrended fluctuation analysis coefficient; or combinations thereof.

16. The method of claim 1, wherein the focusing optical system is a polymeric photoconcentrator having a convergent lens, being arranged at the tip of an optical fibre or waveguide and wherein the lens has a focusing spot corresponding to a beam waist of ⅓th to ¼th of a base diameter of the lens.

17. (canceled)

18. The method of claim 1, wherein the lens has a Numerical Aperture, NA, above 0.5, or 0.25<NA<0.5 in water medium.

19. The method of claim 1, wherein the lens has a base diameter of 5-10 μm, and the lens is spherical and has a length of 30-50 μm.

20. (canceled)

21. The method of claim 1, wherein the infrared light receiver is a photoreceptor comprising a bandwidth of 400-1000 nm.

22. (canceled)

23. (canceled)

24. The method of claim 1, wherein the signal capture is carried out at least a sampling frequency of at least five times the modulation frequency.

25. The method of claim 1, wherein the signal capture comprises a high-pass filter.

26. The method of claim 1, wherein the modulation frequency is equal or above 1 kHz.

27.-39. (canceled)
